(19) United States
(12) Patent Application Publication
(10) Pub. No.: US 2026/0048429 A1
(43) Pub. Date: Feb. 19, 2026

(54) PRESS TOOL HOLDER, PRESS TOOL, PRESS TOOL SYSTEM, PRESS TOOL MACHINE AND METHOD FOR PRODUCING A PRESS MOULDING AND METHOD FOR ADJUSTING A PRESS TOOL MACHINE OR A PRESS TOOL HOLDER

(71) Applicant: KAMAX Holding GmbH & Co. KG, Homberg (Ohm) (DE)

(72) Inventors: Maximilian Schreiber, Giessen (DE); Christoph Haust, Schwalmstadt Treysa (DE); Christian Ludwig, Darmstadt (DE); Hilmar Gensert, Bad Dueben (DE)

(73) Assignee: KAMAX Holding GmbH & Co. KG, Homberg (Ohm) (DE)

(21) Appl. No.: 19/102,121

(22) PCT Filed: Aug. 2, 2023
(86) PCT No.: PCT/EP2023/071376

§ 371 Date: Feb. 7, 2025

(30) Foreign Application Priority Data
Aug. 8, 2022 (DE) 10 2022 119 883.9

(51) Int. Cl. B21D 28/26; B25J 11/00

(52) U.S. Cl. CPC B21D 28/265; B25J 11/005

(57) ABSTRACT

Press tool holder (10), comprising a press tool attachment (11) extending in the longitudinal direction (L) and a primary tool adjustment (20), wherein the press tool attachment (11) serves to hold a press tool (100), wherein the primary tool adjustment (20) has an X-direction adjustment (22) and Y-direction adjustment (24), wherein the X-direction adjustment (22) enables a change in position of the press tool (100) in the X-direction (X), wherein the Y-direction adjustment (24) enables a change in position of the press tool (100) in the Y-direction (Y), wherein the X-direction adjustment (22) is independent of the Y-direction adjustment (24), wherein the X-direction (X), the longitudinal direction (L) and the Y-direction (Y) are each perpendicular to one another.

### CROSS-REFERENCE TO RELATED APPLICATIONS

This application is a U.S. National Stage Application under 35 U.S.C. § 371 of International Application No. PCT/EP2023/071376, filed Aug. 2, 2023, which claims the benefit of and priority to German Patent Application No. DE 10 2022 119 883.9, filed Aug. 8, 2022, the contents of which are hereby incorporated herein by reference in their entireties.

### TECHNICAL FIELD

The invention relates to a press tool holder, a press tool, a press tool system, a press tool machine and/or a method for producing a press moulding and/or a method for adjusting a press tool machine and/or a press tool holder

### BACKGROUND

Press tools and holders in press moulding machines for these tools are already known from the state of the art. These are used to reshape a blank by press forming in order to produce a component or semi-finished product. However, the problem with the systems or devices known in the current state of the art for holding press tools is that their adjustment is very time-consuming and/or that the set-up times are particularly long.

### SUMMARY

It is therefore the task of the invention to save personnel time for setting up or adjusting press tools or press tool machines.

This task is solved with a press tool holder according to claim 1, with a press tool according to claim 9, with a press tool system according to claim 10, with a press tool machine according to claim 11 and with a method for manufacturing or adjusting a press tool machine according to claim 17. Further advantages, features and embodiments are shown in the sub-claims of the description and the figures.

The invention is a press tool holder. The press tool holder comprises a press tool attachment extending in particular in the longitudinal direction and/or a primary tool adjustment, wherein the press tool attachment serves or can serve to hold a press tool, wherein the primary tool adjustment has an X-directional adjustment and a Y-directional adjustment, wherein the X-directional adjustment enables or can enable a change in position of the press tool in the X-direction, wherein the Y-directional adjustment enables or can enable a change in position of the press tool in the Y-direction, wherein the X-directional adjustment is independent of the Y-directional adjustment, wherein the X-direction, the longitudinal direction and the Y-direction are or can be perpendicular to each other. The press tool holder is used to hold a press tool and support it against a base and/or a press tool machine. The press tool holder can be mounted on a press tool machine or form part of the press tool machine. Overall, the press tool holder can therefore be or comprise a tool attachment. In order to hold the press tool securely, the press tool holder has a press tool attachment, which can in particular have a circular cross-section, especially in a plane perpendicular to the longitudinal direction. The press tool attachment allows the press tool or a press tool to be inserted into it. Advantageously, the press tool holder or material of the press tool holder completely encloses the press tool attachment in a plane perpendicular to the longitudinal direction. In other words, the press tool attachment can be limited perpendicular to the longitudinal direction by the press tool holder or by a casing. The press tool attachment extends in particular in the longitudinal direction. In particular, the longitudinal direction is the direction in which the press tool can be inserted into the press tool attachment. Alternatively or additionally preferably, the longitudinal direction can ultimately also be the direction in which the press tool has its largest main dimension and/or in which the machining of the workpiece ultimately takes place or in which direction the punch is moved in relation to the die during the final pressing process. In addition to the press tool attachment, the tool holder also has a primary tool adjustment. The primary tool adjustment in turn has an X-direction adjustment and a Y-direction adjustment. The X-direction and the Y-direction can advantageously be perpendicular to each other and/or orientated perpendicular to the longitudinal direction. In other words, the X-direction, the Y-direction and the longitudinal direction can form an orthogonal coordinate system with each other. The X-direction adjustment is designed in such a way that, if a press tool is present in its final or intended position within the press tool attachment, the X-direction adjustment enables the position of the press tool to be changed in the X-direction. The intended position is, in particular, the position within the press tool attachment that the press tool should and/or must occupy for a pressing process. In the same way, the Y-direction adjustment is designed in such a way that it enables or can carry out a change in position of the press tool in the Y-direction. A change of position means in particular that the tool or press tool can be brought into a new position which differs from the former position or position of the tool within the press tool attachment, whereby the tool or press tool can also be used for a pressing process in the new position. In other words, the X-direction adjustment and the Y-direction adjustment can each be used to change the position of the press tool within the press tool attachment or within the press tool holder. This ultimately makes it possible to compensate for and/or eliminate the effects of wear, temperature-related distortion and/or other unwanted changes in the position of the tool and/or other workpiece deviations from a target production. In particular, the X-direction adjustment and the Y-direction adjustment are independent of each other. Independent means, in particular, that in the case of a change in position in the X-direction, there is a necessary displacement in the Y-direction and/or in the longitudinal direction only due to the applicable tolerances. The same applies to the Y-direction adjustment, which does not require any change in position in the X-direction and/or longitudinal direction due to its independence. In particular, however, an X-direction adjustment can possibly bring about a change in longitudinal direction, but not a change in Y-direction. This can also or alternatively apply to the Y-direction adjustment. The independence of the X-direction adjustment from the Y-direction adjustment means that a particularly fast and effective adjustment can be achieved, especially after replacing the press tool.

Preferably, the X-direction adjustment and/or the Y-direction adjustment and/or the press tool holder are designed in such a way that they hold or can hold the press tool in the X-direction or Y-direction. In other words, the X-direction adjustment can be designed in such a way that it can ultimately prevent a displacement of the press tool in the X-direction in relation to the press tool holder and/or the press tool attachment, in particular by form locking and/or force locking. In the same way, the Y-direction adjustment can also be designed in such a way that it can prevent a change in position of the press tool in the Y-direction in relation to the press tool holder and/or the press tool attachment, in particular by form locking and/or force locking. This enables secure positioning of the press tool within the press tool attachment.

Preferably, the press tool holder has a secondary adjustment, wherein the secondary adjustment has a longitudinal direction adjustment, wherein the longitudinal direction adjustment has an L-actuation, wherein the L-actuation causes or can cause a displacement of the press tool in the longitudinal direction by a displacement along and/or by a rotation about an L-actuating axis. In other words, the press tool holder can also have a secondary adjustment, wherein the secondary adjustment has at least one longitudinal direction adjustment, by means of which a press tool, in particular a press tool held in the press tool attachment, can be displaced in the longitudinal direction in relation to the press tool holder and/or in relation to the press tool attachment. “In relation to the press tool holder” means in particular that the centre of gravity of the press tool holder can be changed in relation to the centre of gravity of the press tool. The longitudinal adjustment has an L-actuation. An L-actuation or essentially an actuation of a directional adjustment is an engagement and/or attack or actuation option of the respective directional adjustment. For example, said actuation can be a handwheel, a tool engagement option, in particular a screw head, or an information connection. The L-actuation can be actuated by displacement and/or rotation about one or the L-actuating axis. Advantageously, the longitudinal adjustment of the press tool can hold it in the longitudinal direction or holds it the longitudinal direction.

Alternatively or additionally preferably, the L-actuation can also have a servomotor for actuation.

Advantageously, the X-direction adjustment has an X-actuation, whereby the X-actuation can be caused or conditioned by a displacement and/or a rotation about an X-actuating axis of a displacement of the press tool in the X-direction. In other words, the X-direction adjustment can have an actuation, which can be referred to as the X-actuation. This X-actuation is also designed, for example, as a form-locking and/or force-locking and/or information actuation. Advantageously, this X-actuation can be a screw head, a hexagon, a handwheel and/or a friction wheel and/or an information input. When the X-actuation is actuated in the form of a displacement and/or a rotation about the X-actuating axis, a press tool located in the press tool attachment can be displaced in the X-direction. In other words, the press tool or a press tool present in the tool attachment can be displaced in the X-direction, for example, by moving the X-actuation in the direction of the X-actuating axis and/or by rotating the X-actuation about the X-actuating axis. This enables particularly simple and compact actuation and adjustment of the press tool within the press tool holder.

Alternatively or additionally preferably, the X-direction adjustment can have a servomotor for actuation.

Advantageously, the Y-direction adjustment has a Y-actuation, whereby the Y-actuation can cause or condition a displacement of the pressing vehicle in the Y-direction by means of a displacement and/or rotation about a Y-actuating axis. The Y-direction adjustment can be designed in a similar way to the X-direction adjustment and/or the longitudinal direction adjustment, whereby the X-direction adjustment can also be designed in a similar way to the longitudinal direction adjustment and/or the Y-direction adjustment. In other words, the features described above with regard to the longitudinal adjustment and/or the X-directional adjustment can also be fundamentally applied to the longitudinal adjustment, the X-direction adjustment and/or the Y-direction adjustment. In other words, the Y-direction adjustment, for example, can therefore also have a Y-actuation in the form of a friction wheel and/or a screw head or a hexagon. Overall, the features described above can therefore be provided in the X-direction adjustment, in the Y-direction adjustment and/or in the longitudinal direction adjustment, irrespective of whether they were disclosed for the X-direction adjustment, the Y-direction adjustment and/or the longitudinal direction adjustment.

Preferably, the X-actuating axis and the Y-actuating axis are parallel to each other. Alternatively, the X-actuating axis and the Y-actuating axis can also be at least essentially parallel to each other. The term “at least essentially parallel” means that the angle between these two axes is a maximum of 10°, preferably a maximum of 5°, particularly preferably a maximum of 1°, and most preferably a maximum of 0.5°. The X-actuating axis and the Y-actuating axis can, in particular, be aligned parallel to the X-direction or the Y-direction. It is particularly preferable if the longitudinal actuating axis, which can also be referred to as the L-actuating axis, is also orientated parallel to the X-actuating axis and/or the Y-actuating axis. This orientation of the actuating axes, in particular the X-actuating axis parallel to the Y-actuating axis, makes it particularly easy to adjust the actuating axes; in particular, for example, a robot head does not have to be reorientated, so that valuable time can be saved when adjusting the press tool or the press tool system.

The X-actuating axis and the Y-actuating axis are particularly preferably parallel to the L-actuating axis. This can further simplify and shorten or speed up the adjustment process, especially with a robot system.

Preferably, the X-actuating axis and the Y-actuating axis are orientated perpendicular to the longitudinal direction, in particular these directions are orientated parallel to a vertical or a horizontal line. In other words, the X-actuating axis and the Y-actuating axis can each be perpendicular to the longitudinal direction. Advantageously, the X-actuating axis and/or the Y-actuating axis can therefore be vertical and/or horizontal. In particular, this can increase the accessibility of the X-actuating axis and/or the Y-actuating axis. This measure therefore also makes it easier to actuate the elements of the primary tool adjustment, so that setting time and therefore also set-up time can be saved, particularly when using a reporter.

Advantageously, the primary tool adjustment has a spindle, whereby the spindle forms or can form part of the X-direction adjustment and/or the Y-direction adjustment. Particularly preferably, both the X-direction adjustment and the Y-direction adjustment can each have a spindle. By using a spindle, in particular a self-locking spindle, a particularly precise setting of the X-direction adjustment and/or the Y-direction adjustment can be achieved. For example, the spindle can be a ball screw and/or form an adjustment system with a ball screw nut. In other words, the X-direction adjustment and/or the Y-direction adjustment can also have a ball screw nut. Alternatively or additionally preferably, the spindle can also have a trapezoidal thread.

Advantageously, the primary tool adjustment has a positive locking displacement device, whereby the positive locking displacement device forms or can form part of the X-directional adjustment and/or the Y-directional adjustment. A positive locking displacement device means that a displacement of the press tool can be brought about by positive locking. For example, such a positive locking displacement device may be an inclined plane. Advantageously, this inclined plane lies with its gradient in the X-Y plane. For example, the inclined plane can be designed in such a way that a displacement in the Y-direction results when the inclined plane is displaced in the X-direction.

Advantageously, the secondary tool adjustment has a spindle, preferably two spindles, with the spindle or spindles forming part of the longitudinal direction adjustment. Advantageously, if two spindles are provided, these two spindles are aligned in parallel to each other. By providing a spindle in a directional adjustment, in particular in the longitudinal direction adjustment, a particularly high degree of adjustability can be achieved, while at the same time achieving a high degree of precision. Advantageously, the spindle of the secondary tool adjustment can have the same features as the spindle of the primary tool adjustment and vice versa.

Advantageously, the press tool holder has an ID, in particular an RFID chip, and/or the press tool holder has an ID read-out device, in particular an RFID reader. By attaching an RFID chip and/or another ID, in particular a barcode, a colour code and/or an identification number to the press tool holder, it can be uniquely identified. This means, for example, that any spindle play or other adjustment options that occur with this press tool holder can be compensated for by presetting, if they are known. This circumstance also ultimately results in faster adjustment of a press tool within the press tool holder. Furthermore or alternatively, the press tool holder can also have an RFID chip reader or an RFID reader which automatically provides the press tool holder with information that makes it possible, for example, to uniquely identify a press tool during assembly. This circumstance can also mean, for example, that the primary tool adjustment and/or the secondary tool adjustment can already be set to match the tool. This can therefore also save setting time.

Advantageously, the press tool holder has a display system and/or an information provision unit, wherein the display system and/or the information provision unit is and/or are designed such that they indicate or can provide information about the setting of the primary tool adjustment, in particular the X-direction adjustment and/or the Y-direction adjustment, and/or the secondary tool adjustment. A display system can, for example, be a digital display unit and/or a reading scale. An information provision unit can be, for example, a wired and/or a wireless information provision unit which provides information about the setting of the primary tool adjustment and/or the secondary tool adjustment. Information about the setting of the primary tool adjustment and/or the secondary tool adjustment by means of the display system and/or by means of the information provision unit makes it easy to read out the position and/or setting of the primary tool adjustment and/or the secondary tool adjustment so that this information can be used, for example, to bring about the same setting at a later time. In particular, if the information displayed and/or provided is stored in conjunction with the press tool present in the press tool holder, the current setting can easily be reproduced at a later time, so that when a press tool and/or a press tool system is converted and/or reset, it can be quickly made ready for production again. The display system and/or the information provision unit can therefore be used to quickly convert and/or adjust the press tool and/or the press tool machine.

A further aspect of the invention may relate to a press tool. Advantageously, the press tool has an ID, in particular an RFID chip. An ID basically allows identification of the element on which the ID is located. The ID can be a barcode, a colour code, an RFID chip, a unique identification number, a serial number or another identification element. By attaching an ID to the press tool, it can be uniquely identified. By identifying the press tool, for example by means of an RFID chip reader or other reader, the press tool can therefore be identified and, in particular, setting time can be saved by using a stored setting for primary tool adjustment and/or secondary tool adjustment-provided by the read-out information for this uniquely identified press tool-and using stored settings for the primary tool adjustment and/or the secondary tool adjustment. Advantageously, settings for the primary tool adjustment and/or secondary tool adjustment can compensate for setting variables, in particular manufacturing deviations (which have been measured previously), for the tool used.

A further aspect of the invention may relate to a press tool system. Advantageously, a press tool system comprises a press tool holder, in particular as described above and/or below, and a press tool, in particular also as described above and/or below. Advantageously, the press tool can be a punch or a die. The invention may therefore relate to a press tool system in which the press tool is a punch or the press tool system can include a press tool which is a die. The punch is characterised in particular by the fact that it performs a translational and/or rotational movement during the forming process. The die, on the other hand, is characterised in particular by the fact that it can be stationary during the pressing process, especially in relation to the base of the press tool machine.

A further aspect of the invention may relate to a press tool machine. Advantageously, said press tool machine may relate to a press tool holder, in particular as described above and/or below, and/or a press tool system, in particular as described above and/or below.

Advantageously, a press tool machine, in particular as described above and/or below, may comprise a robot system, wherein the robot system has an actuating unit for primary tool adjustment and/or for secondary tool adjustment of a press tool holder, in particular a press tool holder of the press tool machine, and/or wherein the robot system can have a gripping unit for a press tool. In other words, the invention may fundamentally relate to a press tool machine with a robot system. The fact that the press tool machine comprises the robot system means in particular only that the robot system interacts and/or can interact with individual components present on and/or in the press tool machine. However, the robot system is particularly preferably mounted on the press tool machine, especially the base of the press tool machine. The robot system can have an actuating unit for primary tool adjustment and/or for secondary tool adjustment, in particular for primary or secondary tool adjustment of a press tool holder of the press tool machine. The actuating unit is used to set the primary tool adjustment and/or the secondary tool adjustment, therefore in particular the X-direction adjustment and/or the Y-direction adjustment and/or the longitudinal direction adjustment. In particular, this makes it possible to set the primary tool adjustment and/or the secondary tool adjustment by means of automated intervention. The actuating unit can have an actuating motor with which the X-direction adjustment and/or the Y-direction adjustment and/or the longitudinal direction adjustment can be actuated. Alternatively, the actuating unit can preferably be actuated by an actuating motor for the X-direction adjustment and/or the Y-direction adjustment and/or the longitudinal direction adjustment. In other words, for example, one motor can be provided for the X-direction adjustment and/or the Y-direction adjustment and another motor of the actuating unit can be provided for the longitudinal direction adjustment. In particular, the actuating unit can be a screw unit. As an alternative preference, the actuating unit can also be and/or comprise a servo unit. Furthermore, alternatively or additionally preferably, the robot system can have a gripping unit for a press tool. This makes it possible, in particular, for the robot system to remove and/or insert a press tool from the press tool machine. Advantageously, the press tool machine and/or the robot system has a storage device for the actuating unit and/or for the gripper unit and/or other robot system attachments. In other words, the robot system can use this storage unit or the storage system to temporarily store and/or stow the actuating unit of the robot system and/or the gripping unit of the robot system. This storage system can also be referred to as a magazine. By providing a robot system, the primary tool adjustment and/or the secondary tool adjustment and a change and/or removal or insertion of a press tool into the press tool machine, in particular into a press tool holder of the press tool machine, can be carried out very quickly and easily.

Use of a press tool holder, in particular as described above or below, and/or a press tool system, in particular as described above or below, for setting a press tool, in particular as described above or below, and/or a press tool machine, in particular as described above or below.

A further aspect of the invention may relate to a press tool machine, in particular as described above and/or below. Advantageously, this press tool machine has a memory, wherein IDs of press tools and/or press tool holders and/or settings for primary tool adjustment, in particular for the X-direction adjustment and/or the Y-direction adjustment and/or for secondary tool adjustment, are stored or can be stored in the memory. In other words, the press tool machine may have a memory or, alternatively, the press tool machine may have access to a memory, wherein a specific setting for the primary tool adjustment and/or for the secondary tool adjustment is stored in the memory for a specific press tool. In other words, the setting for the primary tool adjustment or the secondary tool adjustment can be assigned to the press tool and/or to a press tool holder and stored in the memory. In particular, the information provided by the display system and/or the information provision unit of a press tool holder can be stored in the memory. By clearly assigning a setting to a press tool and/or a press tool holder, the primary tool setting and/or the secondary tool setting can be adjusted in a particularly effective way, saving valuable set-up and/or adjustment time. This adjustment can again advantageously be carried out by the robot system, in particular by the actuation unit of the robot system, advantageously automatically, therefore in particular without the intervention of an operator.

A further aspect may also relate to a press tool machine, in particular as described above and/or below, wherein the press tool machine, in particular the robot system, has an ID readout device, in particular an RFID chip reader. Alternatively, the press tool holder can also preferably have an ID read-out device. This provides a particularly fast and effective way of determining an ID, in particular the ID of a press tool. The ID readout device can be a visual readout device, for example, in particular a barcode reader and/or a camera. Advantageously, the ID readout device can be connected to a memory, in particular to a/the memory as described above with regard to the tool machine. A relationship between the ID found and a setting for the primary tool adjustment and/or for the secondary tool adjustment can be stored in this memory.

Advantageously, the invention can relate to a press tool machine, in particular as described above and/or below, wherein the press tool machine has a measuring device and/or an input device, in particular for measurement data of a manufactured workpiece. The press tool machine can therefore have a device, in particular a measuring device and/or an input device for measurement data, whereby the measuring device can in particular measure a manufactured workpiece with regard to predefined dimensions or definable dimensions. In particular, the measuring device can be arranged in an ejection area or a discharge from the press tool machine, which can also be referred to as a tool machine for short in the context of the application. Alternatively or additionally preferably, the measuring device can also be fed by the robot system. In other words, the robot system can also feed the workpieces to be measured to the measuring device. The measuring device can, for example, be a non-contact measuring device, in particular a laser, a capacitive and/or inductive proximity switch and/or a light barrier and/or a camera. The input device, on the other hand, can be a keyboard or a number pad, for example. By communicating measured values or measurement data in particular of a manufactured workpiece, which can be read into the tool machine by the measuring device, and/or by entering the measurement data, it is ultimately possible to determine how an adjustment, in particular of the primary tool adjustment and/or the secondary tool adjustment, should be made on the basis of this measurement data. In particular, the input device can be part of a robot system. In particular, however, the robot system is connected (by information technology) to the measuring device and/or to the input device, whereby ultimately a control unit can be located between the robot system and the measuring device or the input device (using information technology). In particular, the control unit can determine a deviation from a target value and use this deviation to transmit and/or determine setting information to/for the robot system for the primary tool adjustment and/or for the secondary tool adjustment.

A further aspect of the invention may relate to a press tool machine, in particular as described above and/or below, wherein the robot system is designed to set the primary tool adjustment and/or the secondary tool adjustment on the basis of the data entered into the input device and/or on the basis of the data recorded by the measuring device. Alternatively, the robot system can preferably or additionally be designed to set the primary tool adjustment and/or the secondary tool adjustment on the basis of the deviation of the data entered into the input device and/or on the basis of the deviation of the data recorded by the measuring device (from a setpoint data set). In other words, the robot system can be used to adjust the primary tool adjustment and/or the secondary tool adjustment based on the acquired data and/or the entered data and/or based on the deviation of the entered data from a target data set and/or based on the deviation of the data acquired by the measuring device from a target data set. In particular, the robot system and/or the press tool machine can have a control device for this purpose, whereby this control device can be or comprise the control unit described above. In other words, an adjustment of the primary tool adjustment, in particular the X-direction adjustment and/or the Y-direction adjustment, and/or the secondary tool adjustment, can be made for a manufacturing deviation and/or on the basis of the values specifically entered. In particular, this can be used to establish a closed control loop and/or to control the adjustment system through the specific input of data. Both of these options, in particular the “closed” control loop, enable particularly time-saving adjustment and/or set-up of the press tool machine.

A further aspect of the invention may relate to a press tool machine, in particular as described above and/or below, wherein the press tool machine is a multi-stage press. In particular, the multiple stages of the press are arranged in the X-direction and/or in the Y-direction. By designing the press tool machine as a multi-stage press, large degrees of forming in particular can be achieved quickly and effectively.

A further aspect of the invention may also relate to a press tool machine, in particular as described above and/or below, wherein each pressing stage of the press tool machine, in particular of a multi-stage press tool machine, comprises a press tool holder, in particular as described above and/or below, and/or wherein each pressing stage, in particular of a multi-stage press, is adjustable by the robot system. This can save a large amount of setting time. This adjustability of the robot system relates in particular to the primary tool adjustment and/or the secondary tool adjustment of each press tool holder. In particular, any press tool holders that have a press tool in the form of a punch and/or those press tool holders that have a press tool in the form of a die can be adjusted by the robot system.

A further aspect of the invention may relate to a method of manufacturing a press moulding and/or a method of adjusting a press tool machine, in particular using a press tool holder as described above and/or below and/or a press tool machine as described above and/or below and/or a press tool system as described above and/or below. Alternatively, the invention may also relate to a method for adjusting a press tool holder and/or a press tool system. All of these methods include the following steps in particular:
a) Provision of a forming blank;
b) Forming of the forming blank, in particular by means of a press tool, advantageously as described above and below, to make a formed part;
c) Measurement of the formed part, in particular by means of a measuring device of the press tool machine;
d) Adjustment of the press tool machine, in particular by the primary tool adjustment, in particular the X-direction adjustment and/or the Y-direction adjustment, and/or the secondary tool adjustment, in particular to minimise deviation of future moulded parts from a target geometry.

The method therefore serves to determine the deviation from a nominal dimension produced by forming the forming blank, in particular by measuring the formed part, wherein the setting of the press tool machine and/or the press tool holder is carried out on the basis of this measurement, in particular on the basis of the deviation of this measurement from a nominal geometry. The adjustment is made in particular in such a way that the deviation from the target geometry is reduced. The adjustment can be carried out by a robot system and/or by hand, for example. Ultimately, the primary tool adjustment can be actuated and/or the secondary tool adjustment can be actuated during the adjustment so that the position of the press tool can be changed in the Y-direction, in the X-direction and/or in the longitudinal direction in relation to the press tool holder or the press tool machine. In particular, this allows an open control loop to be created and/or the beginnings of a closed control loop to be established.

A further development of the method can in particular comprise repeating steps b) to d) or a) to d) until the measurement of the formed part or the formed part newly produced in each case by running steps b) to d) or a) to d) shows that the deviation from a target geometry has fallen below a defined threshold. The deviation from the target geometry can relate in particular to the deviation of a single dimension and/or an average value of various dimensions. By continuously repeating steps b) to d) or even steps a) to d), a closed control loop can be achieved in particular in order to ultimately achieve a final setting automatically and/or semi-automatically, with only a few manual steps or operator interventions. In particular, this method can also be designed in such a way that the method is used during a series production cycle in order to reduce the deviations from a nominal dimension that occur during the series production of formed parts by adjusting the press tool machine or by adjusting the press tool holder(s). Advantageously, as already mentioned, the adjustment is carried out by a robot system in order to provide a particularly high degree of injury safety.

### BRIEF DESCRIPTION OF THE DRAWINGS

Further advantages and features of the present invention are shown in the following description with reference to the figures. Individual features of the embodiments shown can also be used in other embodiments, unless this has been expressly excluded. The figures include:

FIG. 1 a schematic view of a press tool holder and a robot system;

FIG. 2 a section through a press tool holder perpendicular to the longitudinal direction;

FIG. 3 a section through a press tool holder along the longitudinal direction;

FIG. 4 a perspective view of a press tool machine;

FIG. 5 a detailed view of a press tool machine with a robot system; and

FIG. 6 also a schematic view of a press tool machine.

### DETAILED DESCRIPTION

FIG. 1 shows a schematic view of a press tool holder 10 and a robot system 300. This arrangement may be part of a press tool machine 1, for example. On the left in the longitudinal direction L, a press tool holder 10 can be seen, which has picked up a press tool 100 in its press tool attachment 11, whereby the press tool 100 is a die. A press tool holder 10 is shown on the right in the longitudinal direction L, which also has a press tool 100 in its press tool attachment 11. The press tool 100 is a punch. The robot system 300 can actuate the primary tool adjustment and the secondary tool adjustment of the left press tool holder 10 with its mounted actuating unit 310. In particular, the actuating unit 310 can therefore actuate the X-direction adjustment, the Y-direction adjustment and the longitudinal direction adjustment by actuating the X-actuation, the Y-actuation and the L-actuation. In the situation shown, the actuating unit is engaged with the Y-actuation. The Y-direction Y is perpendicular to the longitudinal direction L.

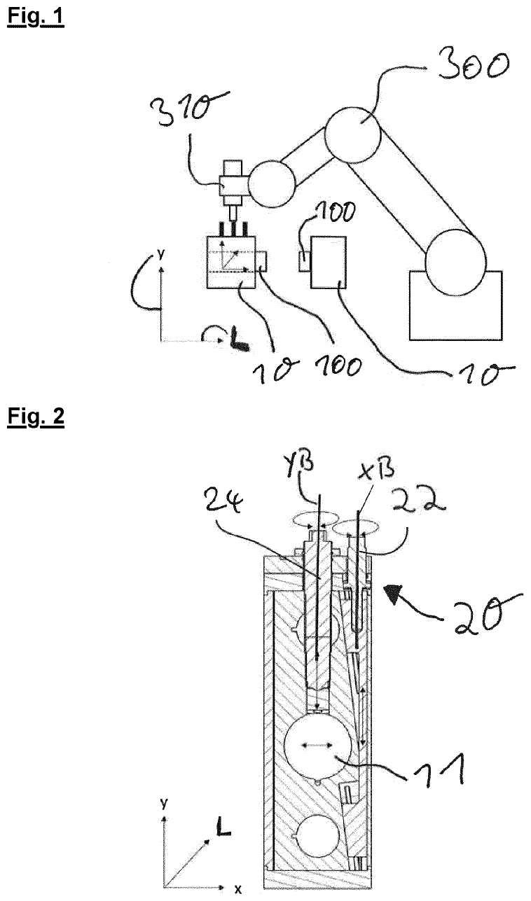

FIG. 2 shows a section through a press tool holder 10, with the sectional plane running perpendicular to the longitudinal direction L. As can be seen in FIG. 2, the Y-direction Y, the X-direction X and the longitudinal direction L form an orthogonal coordinate system. The press tool holder 10 has a primary tool adjustment 20, which comprises the X-direction adjustment 22 and the Y-direction adjustment 24. In order to be able to actuate the X-direction adjustment 22, a rotational movement around the X-actuating axis XB must be carried out. On the other hand, in order to adjust the Y-direction adjustment 24, a rotation about the Y-actuating axis YB must be brought about. The X-actuating axis XB and the Y-actuating axis YB are aligned in parallel to each other. In the example shown, the X-direction adjustment 22 is based on two inclined planes spaced apart in the Y-direction.

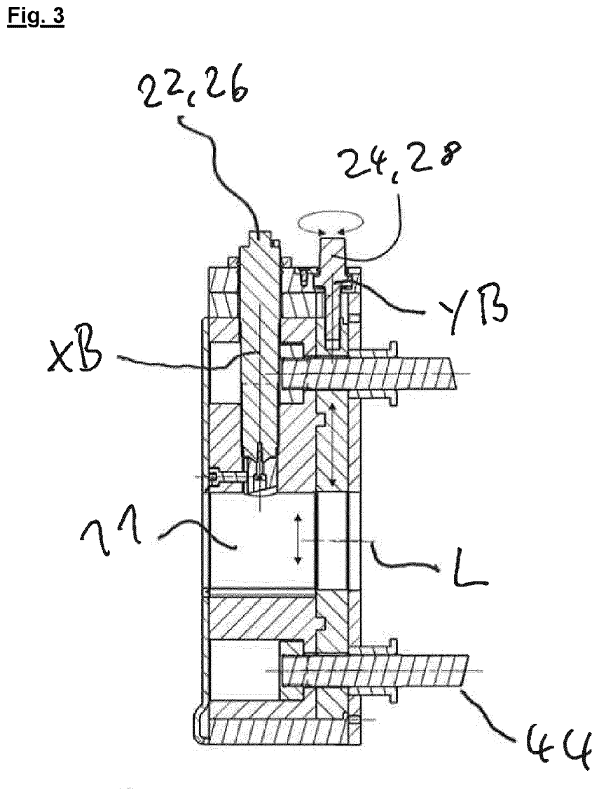

FIG. 3 shows a sectional view of a press tool holder 10, wherein the press tool holder 10 has a Y-direction adjustment 24, wherein the Y-actuation 28 must be actuated in order to actuate this Y-direction adjustment 24. An X-direction adjustment 22 is also provided in the press tool holder 10. In addition to these elements of the primary tool adjustment 20, the illustrated device also has a secondary adjustment 40 in the form of an L-actuation 44.

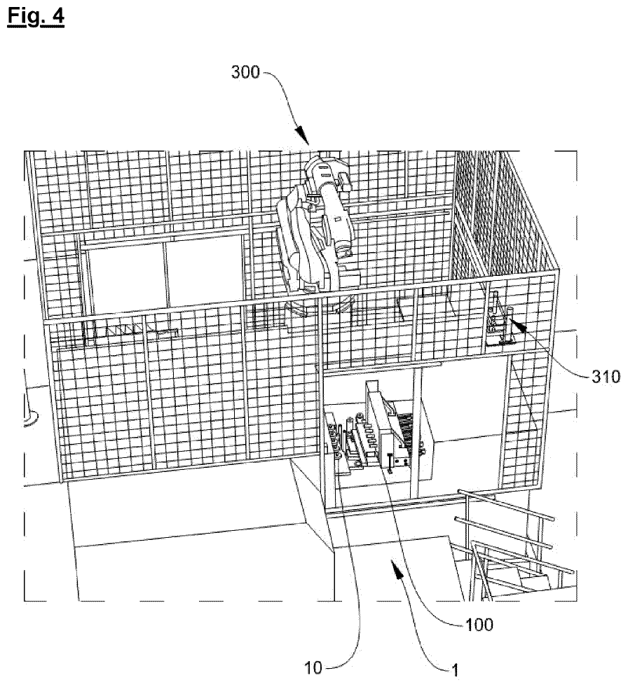

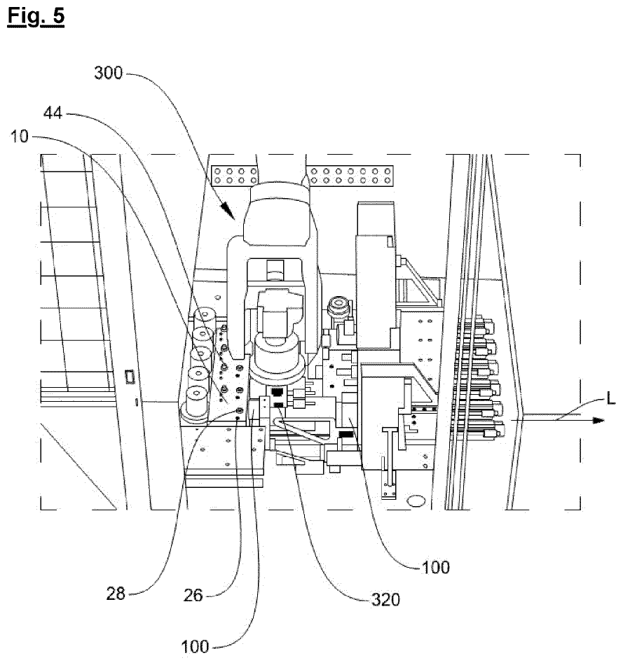

FIG. 4 shows a perspective overall view of a press tool machine 1. In the press tool machine 1, which is designed as a multi-stage press, there are numerous press tool holders 10, which are arranged next to each other, in particular next to each other in the X-direction or Y-direction. A press tool 100 in the form of a die is positioned opposite a press tool 100 in the form of a punch. The press tool machine 1 has a robot system 300. The actuating unit 310 of the robot system 300 is mounted in a magazine of the robot system 300 or the press tool machine 1. This magazine can be reached by an arm of the robot system 300 in order to pick up the actuation unit and actuate the primary tool adjustment and/or the secondary tool adjustment.

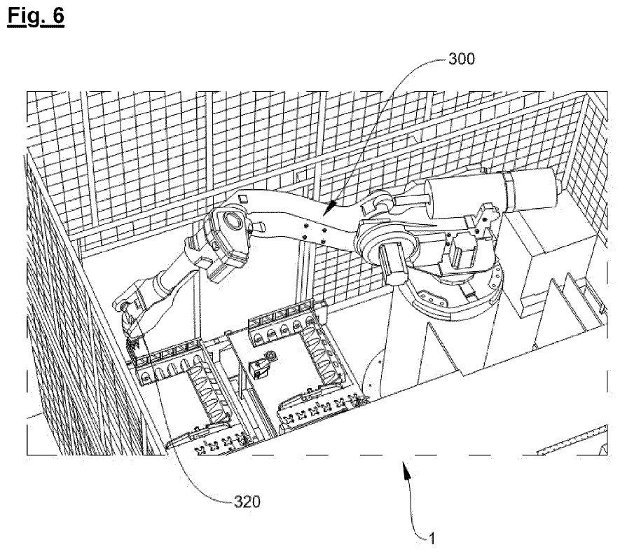

FIG. 5 shows a detailed view of a press tool machine 1, in particular the working area or pressing area of the press tool machine. As can be seen schematically in FIG. 5, this has press tool holders 10 arranged next to one another, each of which has a press tool 100 in the form of a die and/or a punch. In particular, FIG. 5 can belong to the embodiments of the press tool machine 1 shown in FIG. 4 and/or in FIG. 6. In order to remove the press tools 100 from the press tool holder 10, a gripper unit 320 is fitted to the arm of the robot system 300. The press tool 100 can be removed from and/or inserted into the press tool holder 10 by means of this gripping unit. In order to be able to adjust the press tool 100 relative to the press tool holder 10, the press tool holder 10 has a primary tool adjustment, which in turn has an X-actuation 26 for the X-direction adjustment and a Y-actuation 28 for the Y-direction adjustment 24. However, in order to be able to achieve a further change in position of the press tool 100 relative to the press tool holder 10, some of the press tool holders 10, in particular all press tool holders and/or all press tool holders which are arranged in a stationary position relative to the foundation of the press tool machines, have an L-actuation for a longitudinal direction adjustment 42, which can be part of the secondary adjustment 40 or can form the same.

FIG. 6 also shows a detailed view of a press tool machine 1, wherein the robot system 300 has a gripping unit 320 and wherein the gripping unit 320 can be guided into a supply area in order to be able to pick up press tools 100 from a supply unit there or to deposit them in a or the supply unit. In particular, the or some of the supply unit(s) can be an exchangeable supply unit, in particular a supply unit located on a carriage and/or a trolley. Advantageously, the press tool machine 1 has at least two storage locations for one supply unit each. In particular, this makes it possible to introduce a completely new set of press tools into the press tool machine 1.

### LIST OF REFERENCE NUMBERS

1—Press tool machine
10—Press tool holder
11—Press tool attachment
20—Primary tool adjustment
22—X-direction adjustment
24—Y-direction adjustment
26—X-actuation
28—Y-actuation
40—Secondary adjustment
42—Longitudinal adjustment
44—L-actuation
100—Press tool
300—Robot system
310—Actuating unit
320—Gripping unit
L—Longitudinal direction
LB—L-actuating axis
X—X-direction
XB—X-actuating axis
Y—Y-direction
YB—Y-actuating axis

1. Press tool holder, comprising:
a press tool attachment extending in the longitudinal direction and a primary tool adjustment,
wherein the press tool attachment serves to hold a press tool,
wherein the primary tool adjustment has an X-direction adjustment and a Y-direction adjustment,
wherein the X-direction adjustment enables a change in position of the press tool in the X-direction,
wherein the Y-direction adjustment enables a change in position of the press tool in the Y-direction,
wherein the X-direction adjustment is independent of the Y-direction adjustment,
wherein the X-direction, the longitudinal direction, and the Y-direction are perpendicular to each other.

2. The press tool holder according to claim 1, wherein the X-direction adjustment and/or the Y-direction adjustment hold the press tool in the X-direction and/or in the Y-direction in each case.

3. The press tool holder according to claim 1,
wherein the press tool holder has a secondary adjustment,
wherein the secondary adjustment has a longitudinal direction adjustment,
wherein the longitudinal direction adjustment has an L-actuation,
wherein the L-actuation can cause or condition a displacement of the press tool in the longitudinal direction by a displacement and/or by a rotation about an L-actuating axis.

4. The press tool holder according to claim 1,
wherein the X-direction adjustment has an X-actuation,
wherein the X-actuation can cause or condition a displacement of the press tool in the X-direction (X) by a displacement of and/or by a rotation about an X-actuating axis.

5. The press tool holder according to claim 4,
wherein the Y-direction adjustment has a Y-actuation,
wherein the Y-actuation can cause or condition a displacement of the press tool in the Y-direction by a displacement of and/or by a rotation about a Y-actuating axis.

6. The press tool holder according to claim 5,
wherein the X-actuating axis and the Y-actuating axis are parallel to each other.

7. The press tool holder according to claim 1,
wherein the primary tool adjustment has a positive locking displacement device,
wherein the positive locking displacement device forms part of the X-direction adjustment and/or the Y-direction adjustment.

8. The press tool holder according to claim 1,
comprising a display system and/or an information provision unit,
wherein the display system and/or the information provision unit is designed such that it indicates or can provide information about the setting of the primary tool adjustment, in particular the X-direction adjustment and/or the Y-direction adjustment.

9. The press tool, according to claim 1,
wherein the press tool has an RFID chip, and/or
wherein the press tool is a punch or a die.

10. A press tool system comprising:
a press tool comprising a punch or a die; and
a press tool holder comprising a press tool attachment extending in the longitudinal direction and a primary tool adjustment,
wherein the press tool attachment serves to hold the press tool,
wherein the primary tool adjustment has an X-direction adjustment and a Y-direction adjustment,
wherein the X-direction adjustment enables a change in position of the press tool in the X-direction,
wherein the Y-direction adjustment enables a change in position of the press tool in the Y-direction,
wherein the X-direction adjustment is independent of the Y-direction adjustment, and
wherein the X-direction, the longitudinal direction, and the Y-direction are perpendicular to each other.

11. A press tool machine comprising:
a press tool holder comprising a press tool attachment extending in the longitudinal direction and a primary tool adjustment,
wherein the press tool attachment serves to hold a press tool,
wherein the primary tool adjustment has an X-direction adjustment and a Y-direction adjustment,
wherein the X-direction adjustment enables a change in position of the press tool in the X-direction,
wherein the Y-direction adjustment enables a change in position of the press tool in the Y-direction,
wherein the X-direction adjustment is independent of the Y-direction adjustment, and
wherein the X-direction, the longitudinal direction, and the Y-direction are perpendicular to each other.

12. The press tool machine, according to claim 11, comprising a robot system,
wherein the robot system has an actuating unit for a primary tool adjustment and/or a secondary tool adjustment, and/or
wherein the robot system has a gripping unit for a press tool.

13. The press tool machine, according to claim 12, including a memory, wherein IDs of press tools and settings for the primary tool adjustment, in particular the X-direction adjustment and/or the Y-direction adjustment, and/or the secondary tool adjustment are stored or can be stored in the memory.

14. The press tool machine, according to claim 13,
wherein the press tool machine has an ID read-out device, in particular an RFID CHIP reader.

15. The press tool machine, according to claim 14,
wherein the press tool machine has a measuring device and/or an input device for measurement data of a manufactured workpiece.

16. The press tool machine, according to claim 11, wherein the press tool machine is a multi-stage press.

17. A method for producing a press moulding and/or for adjusting a press tool machine using a press tool system according to claim 10, comprising the steps of:
a) Provision of a forming blank;
b) Forming of the forming blank by means of a press tool to make a formed part;
c) Measuring of the formed part by means of a measuring device of the press tool machine;
d) Adjustment of the press tool machine by the primary tool adjustment, in particular the X-direction adjustment and/or the Y-direction adjustment, and/or the secondary tool adjustment for minimisation.
